(19) United States
(12) Patent Application Publication
(10) Pub. No.: US 2012/0198962 A1
(43) Pub. Date: Aug. 9, 2012

(54) Hybrid Vehicle Transmission

(75) Inventor: Martin Houle, Laval (CA)

(73) Assignee: TM4 INC., Boucherville, QC (CA)

(21) Appl. No.: 13/500,758

(22) PCT Filed: Nov. 2, 2010
(86) PCT No.: PCT/CA2010/001768

§ 371 Date: Apr. 6, 2012

Related U.S. Application Data
(60) Provisional application No. 61/272,786, filed on Nov. 3, 2009.

(51) Int. Cl. F16H 37/06

(52) U.S. Cl. 74/661; 903/902

(57) ABSTRACT

A transmission for a Series/Parallel Hybrid Vehicles (SPHV) enabling the vehicle to switch between series and parallel modes while the vehicle is in motion and while both the traction motor and the prime mover are operating at efficient levels is described herein. The traction motor and the prime mover are connected to an intermediate shaft via different ratio gear assemblies. A clutch is provided between the prime mover gear assembly and the intermediate shaft to allow the switch between the series mode and the parallel mode.

### FIELD

The present invention generally relates to hybrid vehicles. More specifically, the present invention is concerned with a transmission for a hybrid vehicle provided with a high speed electric motor.

### BACKGROUND

Hybrid vehicles are well known in the art. They are often provided with an internal combustion engine (ICE), an electric traction motor that may transmit power to at least one wheel of the vehicle and an electric generator used to supply electricity to the traction motor and/or to recharge batteries of the vehicle.

On the one hand, a hybrid vehicle is said to be a series hybrid vehicle when the electric traction motor is used to drive the wheels and the ICE is exclusively used to drive the electric generator to recharge the vehicle's batteries and/or supply electric power directly to the traction motor.

On the other hand, a hybrid vehicle is said to be a parallel hybrid drive train when both the traction motor and the ICE may be used simultaneously or individually to drive the wheels of the vehicle. In parallel hybrid drive trains, the ICE may also be used to recharge the batteries through the electric generator.

Series/parallel hybrid vehicles (SPHV) are also known in the art. Conventionally, these vehicles include drive trains that may be switched between a series mode and a parallel mode, as described hereinabove.

Hybrid vehicle transmissions are also known in the art to interconnect the ICE, the electric traction motor and the electric generator. However, since the rotational speed at which an electric traction motor is most efficient and the rotational speed at which an ICE is most efficient are different speeds, it is a challenge to design a transmission for such a hybrid vehicle when it is desired to allow both serial and parallel hybrid modes.

### BRIEF DESCRIPTION OF THE DRAWINGS

In the appended drawings:

FIG. 1 is a schematic sectional view of a hybrid transmission according to a first illustrative embodiment; an ICE and a electric Motor/Generator are shown connected to the transmission; the transmission being shown in series hybrid mode;

FIG. 2 is a schematic sectional view similar to FIG. 1 but illustrating the transmission in a parallel mode;

FIG. 3 is a schematic sectional view of the hybrid transmission of FIG. 1 illustrated with a different configuration of the ICE, electric traction motor and electric generator;

FIG. 4 is a schematic sectional view of a hybrid transmission according to a second illustrative embodiment; an ICE, an electric traction motor and an electric generator are shown connected to the transmission;

FIG. 5 is a sectional view taken along line 5-5 of FIG. 3;

FIG. 6 is a schematic sectional view of the hybrid transmission of FIG. 1 illustrated with a different interconnection of the ICE thereto; and

FIG. 7 is a schematic sectional view of a hybrid transmission according to a third illustrative embodiment; an ICE, an electric traction motor and an electric generator are shown connected to the transmission.

### DETAILED DESCRIPTION

In accordance with an illustrative embodiment, there is provided a transmission for a hybrid vehicle provided with a prime mover and with a traction motor, the transmission comprising:

a prime mover input;

a traction motor input;

an output shaft

an intermediate shaft generally parallel with the output shaft;

a traction motor gear assembly interconnecting the traction motor input to the intermediate shaft;

a prime mover gear assembly releasably interconnecting the prime mover input to the intermediate shaft via a clutching assembly so configured as to be moved between clutched and unclutched positions; and

an output gear assembly interconnecting the intermediate shaft to the output shaft;

wherein, the transmission is in a series mode when the clutching assembly is in the unclutched position and the transmission is in a parallel mode when the clutching assembly is in a clutched position.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification, the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

It is to be noted that the expressions “clutch” and “clutching assembly” are to be construed herein and in the appended claims as any mechanical or electromechanical element or assembly allowing engagement and disengagement of two rotating elements such as shafts. Friction clutch and jaw clutch are non-limiting examples of clutch and clutching assemblies.

Other objects, advantages and features of the present invention will become more apparent upon reading of the following non-restrictive description of illustrative embodiments thereof, given by way of example only with reference to the accompanying drawings.

Generally stated, illustrative embodiments described herein are concerned with a transmission for a Series/Parallel Hybrid Vehicles (SPHV) enabling the vehicle to switch between series and parallel modes while the vehicle is in motion and while both a traction motor, for example an electric traction motor, and a prime mover, for example an ICE, are operating at efficient levels. This is possible since the electric traction motor and the ICE are connected to an intermediate shaft via different ratio gear assemblies. A clutching assembly is provided between the ICE gear pair and the intermediate shaft to allow the switch between the series mode and the parallel mode.

It is to be noted that the appended figures are schematic and that many mechanical and electronic components that are not directly related to the present disclosure are not illustrated thereon, for concision purpose.

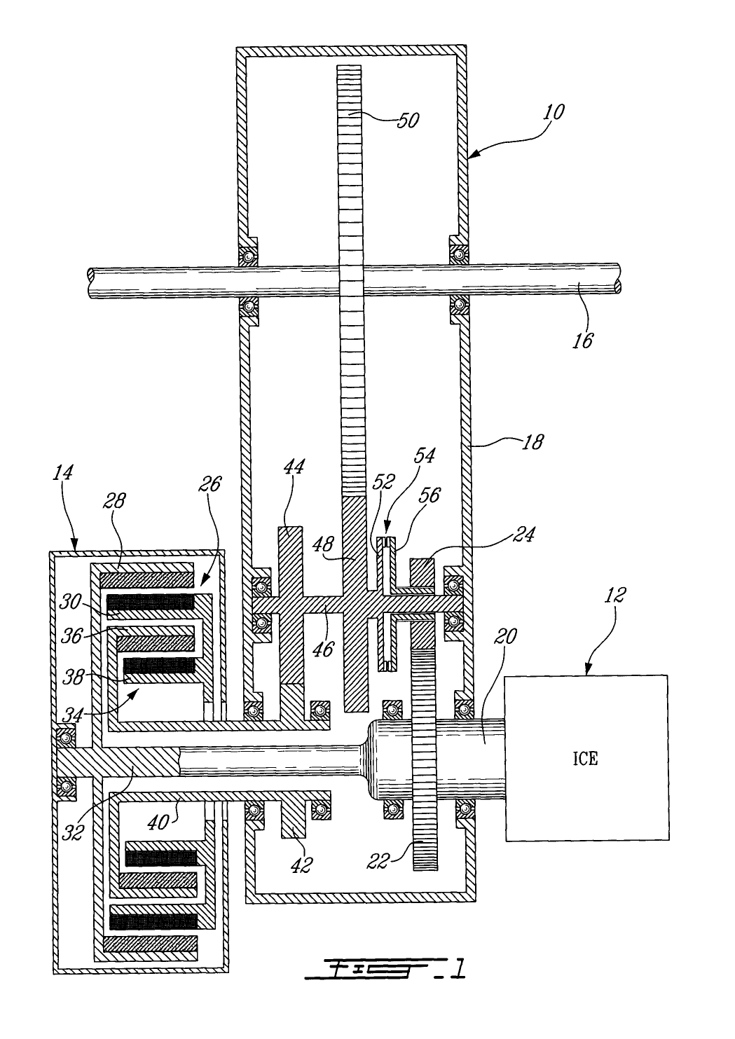

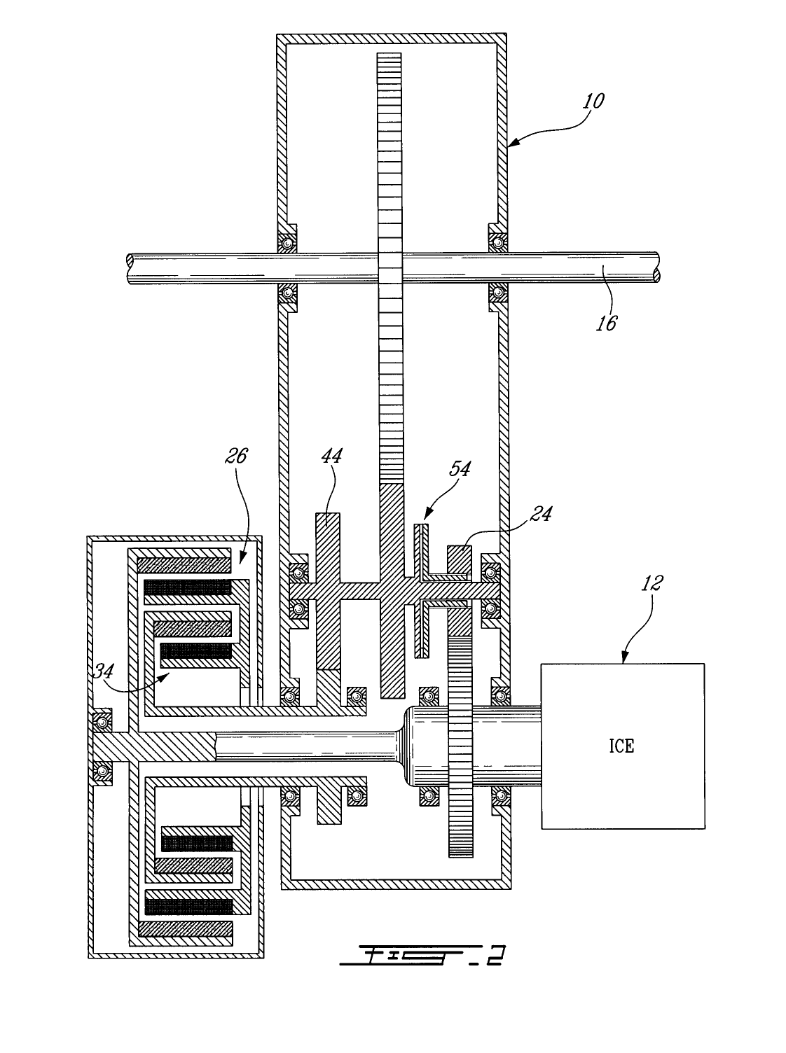

Turning now to FIGS. 1 and 2 of the appended drawings a transmission 10 for a hybrid vehicle according to a first illustrative embodiment will be described. The transmission 10 is connected to an ICE 12 via a prime mover input, to an electric motor/generator 14 and to the wheels of the vehicle via an output shaft 16. The various elements of the transmission 10 are located in a transmission enclosure 18.

The ICE 12 includes a shaft 20 to which is mounted a first gear 22 meshed with a second gear 24 defining a prime mover gear assembly.

The electric motor/generator 14 includes an electric generator 26 including an external rotor 28 and an internal stator 30. The external rotor 28 is mounted to a shaft 32 through a generator input of the transmission 10. The shaft 32 is the continuation of the shaft 20 of the ICE 12. Accordingly, the ICE 12 and the generator 26 are permanently connected in this illustrative embodiment.

The electric motor/generator 14 also includes an electric traction motor 34 including an external rotor 36 and an internal stator 38. The external rotor 36 is mounted to a hollow shaft 40 enclosing the shaft 32 of the generator 26. The hollow shaft 40 enters the transmission 10 through a traction motor input. Accordingly, the electric generator 26 and the electric traction motor 34 can be coaxial and mounted in the same enclosure to reduce the overall dimensions thereof.

The hollow shaft 40 includes an integral third gear 42 meshed with a fourth gear 44 defining a traction motor gear assembly.

The fourth gear 44 is integral with an intermediate shaft 46. The output shaft 16 is connected to the intermediate shaft 46 via an output gear assembly including a fifth gear 48, integral with the intermediate shaft 46, meshed with a sixth gear 50 mounted to the output shaft 16.

The intermediate shaft 46 includes the fixed portion 52 of a jaw clutch 54, while the second gear 24 is mounted to the intermediate shaft 46 via the mobile portion 56 of the jaw clutch 54. For example, the mobile portion 56 and the second gear 24 can be mounted to one another via a spline assembly allowing longitudinal movements of the mobile portion 56 towards the fixed portion 52.

The jaw clutch 54 includes an actuator (not shown) controlled by a controller (not shown) that actuates the mobile portion 56 of the jaw clutch between the disengaged position shown in FIG. 1 and the engaged position shown in FIG. 2.

As is apparent from FIG. 1, the mobile portion 56 of the jaw clutch 54 is shown disengaged from the fixed portion 52, the jaw clutch therefore being in an unclutched position. The transmission 10 is therefore in a series mode.

One skilled in the art will understand that the jaw clutch 54 could be replaced by clutch assemblies using other clutching technologies.

Indeed, as will easily be understood by one skilled in the art, the electric traction motor 34 is permanently associated with the output shaft 16 via the electric traction motor gear pair 42, 44 and the output gear pair 48, 50; while the ICE is permanently associated with the electric generator 26 via their respective shafts 20 and 32. The electric generator 26, driven by the ICE 12 therefore recharge the batteries when required (not shown) and the electric traction motor 34 drives the wheels (not shown) of the hybrid vehicle.

When the jaw clutch 54 is in the engaged position as shown in FIG. 2, the hybrid vehicle transmission 10 is in the parallel hybrid mode. When the jaw clutch 54 is in such a clutched position, the electric traction motor 34, via the electric traction motor gear pair 42, 44 and the output gear pair 48, 50, and the ICE, via the ICE gear pair 22, 24 and the output gear pair 48, 50, drive the output shaft 16, therefore driving the wheels (not shown) of the vehicle.

It is to be noted that the controller (not shown) is also used to control the electric traction motor 34, the electric generator 26 and the ICE 12. Furthermore, speed sensors (not shown) are also optionally connected to these devices to monitor their respective rotation speeds and to send this real time data to the controller.

Accordingly, the controller may determine that a portion of the power supplied by the ICE 12 is to be used by the generator 26 to recharge the batteries even in the parallel mode shown in FIG. 2 and control the generator 26 accordingly.

One skilled in the are will understand that before engaging the clutch 54, the speed of the second gear 24 must be adjusted so that there is no appreciable speed difference between the second gear 24 and the intermediate shaft 46 to prevent unwanted driver perceptible jerks. One method to adjust the speed of the second gear 24 is to control the ICE 12 so that it is in an idle mode and then adjust the speed of the electric generator 26 to bring the second gear 24 to the speed of the intermediate shaft 46.

One skilled in the art is believed able to determine the individual ratios of the ICE gear pair, the traction motor gear pair and the output gear pair depending on the different efficient speeds of the electric motor and of the ICE to allow the clutch to switch between the series mode and the parallel mode while the hybrid vehicle is in motion. Other considerations can be taken into account in the determination of the ratios of the gear pairs. Non-limiting examples of these considerations include the noise level of the ICE 12 when the vehicle is at cruising speed; and the vehicle speed at which the transmission may be switched in parallel mode without stalling the ICE.

It will be understood by one skilled in the art that by adjusting the gear ratios of the ICE gear pair with respect to the traction motor gear pair it is possible to use an electric traction motor that is efficient at a much higher rotational speed than the efficient rotational speed of the ICE while both are connected to the intermediate shaft 46.

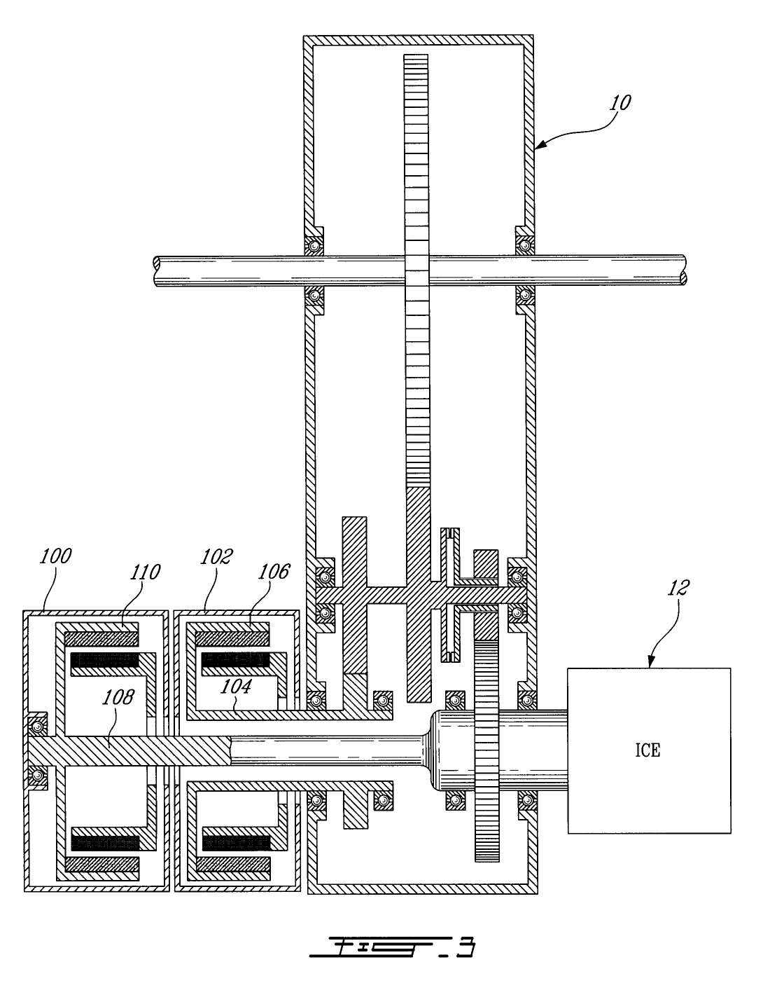

Turning now to FIG. 3 of the appended drawings, another configuration of the electro-mechanical components associated with the transmission 10 will be briefly described.

Generally stated, the electric motor/generator 14 has been replaced with an electric generator 100 and an electric motor 102. As can be seen from this figure, the electric motor 102 has a hollow shaft 104 to which the external rotor 106 is mounted. The electric generator 100 has its shaft 108, to which the external rotor 110 is mounted, traversing the hollow shaft 104. Accordingly, both the interconnections of the electric generator 102 and of the electric motor 104 to the transmission 10 and the operation of the transmission 10 are identical to those described above and illustrated in FIGS. 1 and 2.

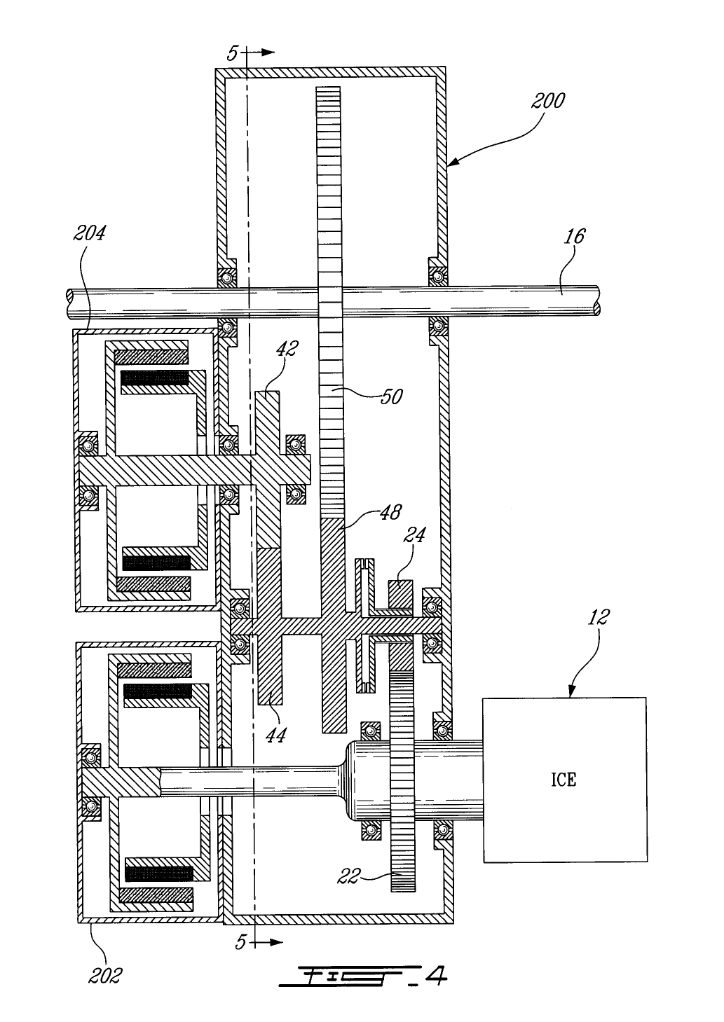

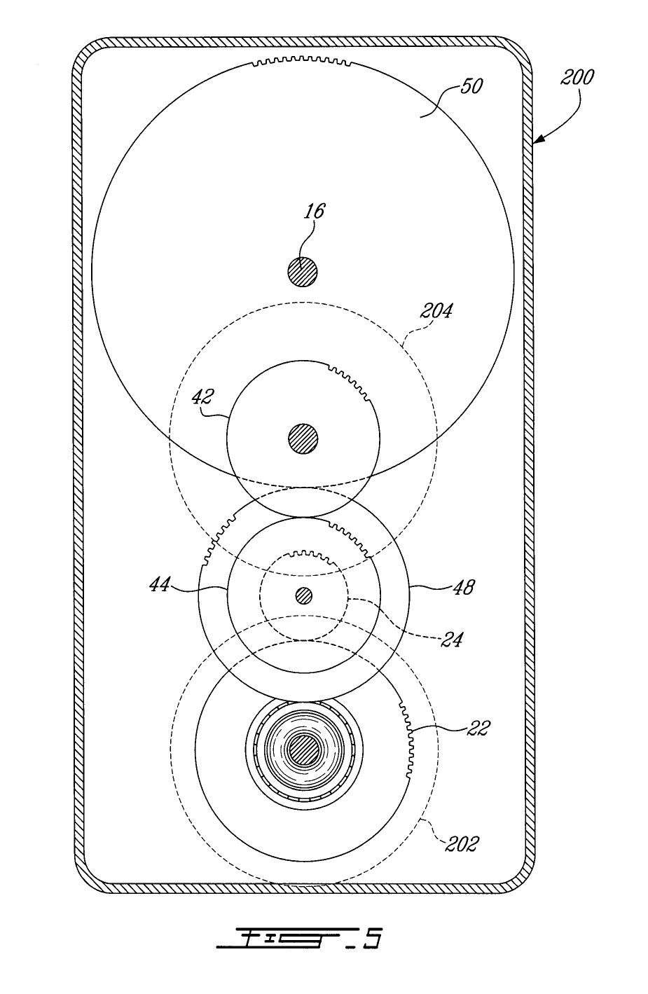

Turning now to FIGS. 4 and 5 of the appended drawings, a transmission 200 according to a second illustrative embodiment will be described. For concision purpose, only the differences between the transmission 10 and the transmission 200 will be described hereinbelow.

As can be seen from FIG. 4, an ICE 12, an electric generator 202 and an electric traction motor 204 are associated with the transmission 200. The gear pairs are identical to the gear pairs of transmission 10 illustrated in FIGS. 1 to 3, but the third gear 42 has been moved around the fourth gear 44 to allow the positioning of the electric generator 202 and the electric traction motor 204 in a non-coaxial manner.

Another difference between the transmission 10 and the transmission 200 is that the casings of the electric machines 202 and 204 are mounted to the casing of the transmission 200 via fasteners (not shown).

The operation of the transmission 200 is identical to the operation of the transmission 10 described hereinabove.

FIG. 5 is a sectional view illustrating the various elements of the transmission 200.

As will easily be understood by one skilled in the art, while the shafts of the electric generator 202 and the electric traction motor 204 are aligned with the output shaft (see FIG. 5), the angular relationship between these shafts could be different, as long as the positioning of these element is adequate to allow the desired gear ratios in the transmission 200.

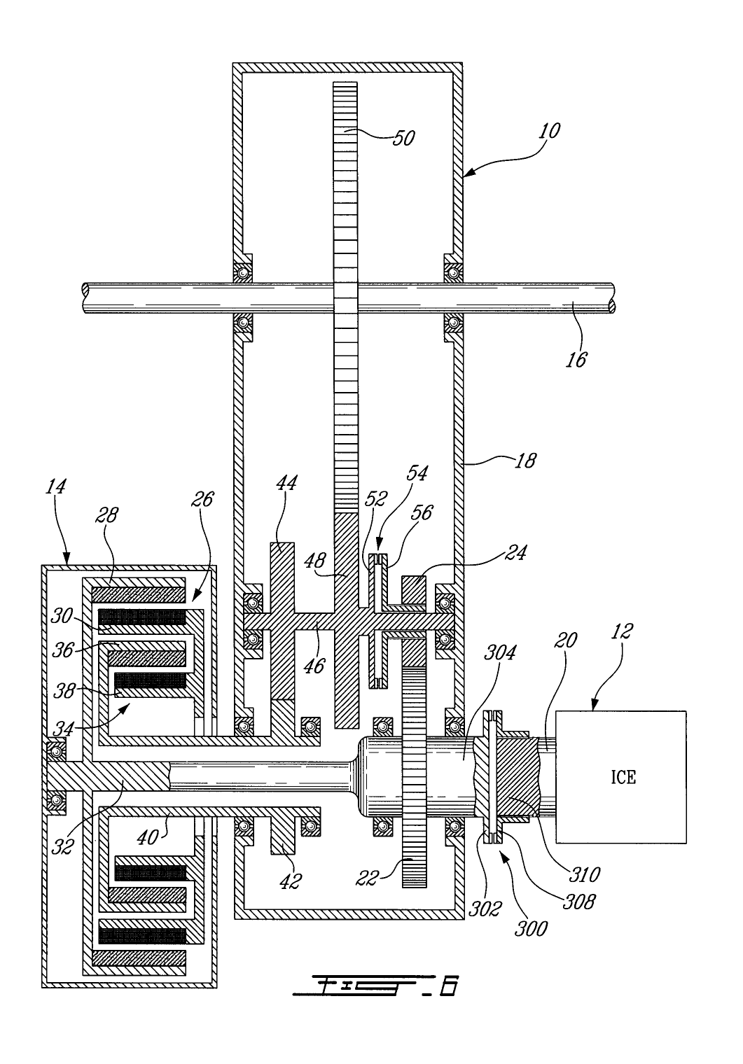

Turning now to FIG. 6 of the appended drawings, another configuration of the electro-mechanical components associated with the transmission 10 will be briefly described. As can be seen from this Figure, the ICE 12 is not permanently connected to the shaft 32 of the electric generator 26 but is removably connected thereto via a jaw clutch 300 including a fixed part 302 associated with a shaft 304, fixedly mounted to the shaft 32, and a mobile part 308 associated with the shaft 20 of the ICE via a splined portion 310 thereof.

Accordingly, when the jaw clutch 300 is engaged, the operation of the transmission 10 is unchanged from the above description since the ICE 12 is connected to the shaft 32.

However, when the jaw clutch 300 is in a disengaged mode, the electric generator 26 may be used as a supplemental traction motor, for example, when a high torque is required at low speeds.

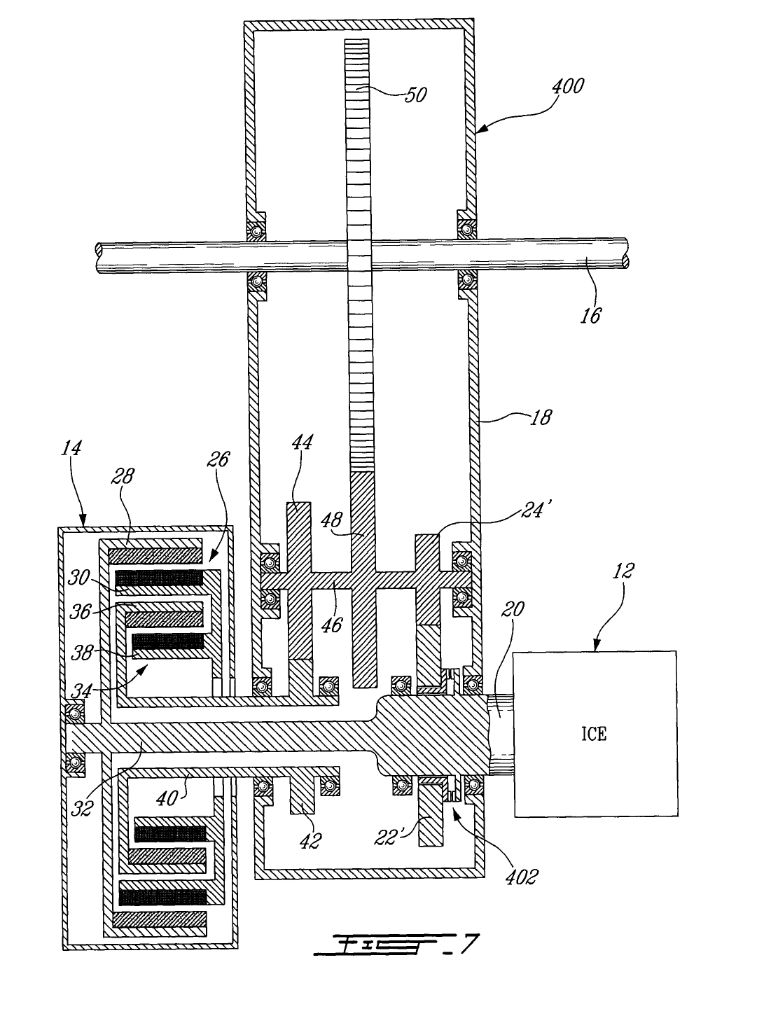

Turning finally to FIG. 7 of the appended drawings, a transmission 400 according to a third illustrative embodiment will be described. Since they are very similar and for concision purpose, only the differences between the transmission 10 and the transmission 400 will be described hereinbelow.

Generally stated, the transmission 400 has the same functionality as the transmission 10 discussed hereinabove. However, instead of mounting the jaw clutch 402 to the second gear 24′, it is installed to the first gear 22′. Accordingly, the first gear 22′ is freewheeling on the shaft 20 of the ICE 12 when the jaw clutch 402 is in the disengaged state illustrated in FIG. 7. When this is the case, the transmission 400 is in the series hybrid mode where the power of the ICE 12 is solely used by the electric generator 26 since the freewheeling first gear 22′ cannot transmit power to the output shaft 16.

However, when the jaw clutch 402 is engaged, the parallel hybrid mode is realized.

It is to be noted that while the hybrid vehicle transmission described hereinabove is associated with and electric traction motor, and electric generator and an ICE, other power sources or prime movers could be used with the above described transmission.

Similarly, while permanent magnet external rotor electric machines are illustrated herein, other electric machines technologies could be used.

It is also to be noted that while only one intermediate shaft 46 is illustrated herein; more than one intermediate shaft could be used should the output gear ratio or the packaging of the transmission require it.

Similarly, while an output gear pair has been described and illustrated herein, other power output assemblies, such as, for example a chain drive having the required speed ratios could be used.

One skilled in the art will understand that while some gears have been described herein as being integral with shafts, these gears could be separate from the shafts and mounted thereto via splines, or key and keyway arrangements, for example.

It will also be understood that the various features of the embodiments and configurations described herein could be combined. As a non-limiting example, the clutch 300 could be installed on any configuration described herein.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention.

What is claimed is:

1. A transmission for a hybrid vehicle provided with a prime mover and with a traction motor, the transmission comprising:
a prime mover input;
a traction motor input;
an output shaft
an intermediate shaft generally parallel with the output shaft;
a traction motor gear assembly interconnecting the traction motor input to the intermediate shaft;
a prime mover gear assembly releasably interconnecting the prime mover input to the intermediate shaft via a clutching assembly so configured as to be moved between clutched and unclutched positions; and
an output gear assembly interconnecting the intermediate shaft to the output shaft;
wherein, the transmission is in a series mode when the clutching assembly is in the unclutched position and the transmission is in a parallel mode when the clutching assembly is in a clutched position.

2. A transmission as recited in claim 1, further comprising a generator input connected to the prime mover input; the generator input being so configured as to be connected to a generator.

3. A transmission as recited in claim 1, wherein the traction motor gear assembly has a first gearing ratio and wherein the prime mover gear assembly has a second gearing ratio; the first and second gearing ratios being so determined that for a given rotational speed of the intermediate shaft, the rotational speed of the traction motor input is faster than the rotational speed of the prime mover input.

4. A transmission as recited in claim 1, wherein the traction motor gear assembly includes a first gear mounted to the traction motor input and a second gear, meshed with the first gear and mounted to the intermediate shaft.

5. A transmission as recited in claim 1, wherein the prime mover gear assembly includes a first gear mounted to the prime mover input and a second gear meshed with the first gear, the clutching assembly including a fixed portion so mounted to the intermediate shaft as to rotate therewith and a longitudinally movable portion rotatably mounted to the intermediate shaft; the second gear being mounted to the longitudinally movable portion.

6. A transmission as recited in claim 1, wherein the prime mover gear assembly includes a first gear and a second gear meshed with the first gear, the clutching assembly including a fixed portion so mounted to the prime mover input as to rotate therewith and a longitudinally movable portion rotatably mounted to the prime mover input; the first gear being mounted to the longitudinally movable portion and the second gear being mounted to the intermediate shaft.

7. A transmission as recited in claim 1, wherein the output gear assembly includes a first gear mounted to the intermediate shaft and a second gear, meshed with the first gear and mounted to the output shaft.

8. A transmission as recited in claim 2, wherein the traction motor input and the generator input are coaxial.

9. A transmission as recited in claim 1, wherein the prime mover input is an ICE input.

10. A transmission as recited in claim 1, wherein the prime mover is mounted to the prime mover input through a second clutching assembly.
